(19) United States
(12) Patent Application Publication
(10) Pub. No.: US 2025/0377318 A1
(43) Pub. Date: Dec. 11, 2025

(54) X-RAY REFLECTION ANALYSIS SYSTEM AND X-REFLECTION ANALYSIS METHOD UTILIZING MULTI-ORDER MODE SIGNALS

(71) Applicant: NanoSeex Inc., Hsinchu County (TW)

(72) Inventors: KUO-FENG LIN, Hsinchu County (TW); TSUNG-HSIEN HAN, Hsinchu County (TW); CHUN-TING LIU, Hsinchu County (TW); PO-CHING HE, Hsinchu County (TW); PO-TSANG WU, Hsinchu County (TW)

(21) Appl. No.: 19/012,827

(22) Filed: Jan. 7, 2025

(30) Foreign Application Priority Data
Jun. 5, 2024 (TW) 113120763

(51) Int. Cl. G01N 23/20008

(52) U.S. Cl. CPC G01N 23/20008; G01N 2223/052; G01N 2223/1016; G01N 2223/304

(57) ABSTRACT

An X-ray reflection analysis system and an X-ray reflection analysis method utilizing multi-order mode signals are provided. The X-ray reflection analysis system includes an X-ray generator, an X-ray optical element group, an X-ray detector and a processing device. The X-ray generator generates a measurement X-ray beam. The X-ray optical element group guides the measurement X-ray beam to a to-be-measured sample. The X-ray detector receives the to-be-measured X-ray signal generated by the measurement X-ray beam irradiating the to-be-measured sample. The processing device collects the to-be-measured X-ray signal and extracts mode signals; performs a first fitting analysis process on the mode signals whose order is less than a predetermined order to generate initial parameter ranges; and based on the initial parameter ranges, performs a second fitting analysis process on the mode signals whose order is greater than or equal to the predetermined order, to generate parameter fitting results.

### CROSS-REFERENCE TO RELATED PATENT APPLICATION

This application claims the benefit of priority to Taiwan Patent Application No. 113120763, filed on Jun. 5, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an analysis system and an analysis method, and more particularly to an X-ray reflection analysis system and an X-ray reflection analysis method utilizing multi-order mode signals.

### BACKGROUND OF THE DISCLOSURE

In current X-ray measurement systems, when analyzing small regions of a sample, the resulting signals are typically weak, requiring extended integration times to acquire data of sufficient quality for meaningful analysis. Furthermore, in cases where the sample undergoes slight structural changes, it is essential to perform measurements at multiple angles to accurately capture these variations and maintain measurement precision. As a result, the total measurement time becomes significantly longer.

In addition, for samples with complex structures, particularly those with multiple layers, even after considerable time is spent acquiring data, the fitting analysis process demands extensive computational resources and time. This, in turn, adversely impacts the overall efficiency of the measurement system.

### SUMMARY OF THE DISCLOSURE

In response to the above-referenced technical inadequacies, the present disclosure provides an X-ray reflection analysis system and an X-ray reflection analysis method utilizing multi-order mode signals.

In order to solve the above technical problems, one of the technical aspects adopted by the present disclosure is to provide an X-ray reflection analysis system utilizing multi-order mode signals, and the X-ray reflection analysis system includes an X-ray generator, an X-ray optical element group, an X-ray detector and a processing device. The X-ray generator is configured to generate a measurement X-ray beam. The X-ray optical element group is configured to guide the measurement X-ray beam to a to-be-measured sample. The X-ray detector is configured to receive the to-be-measured X-ray signal generated by the measurement X-ray beam irradiating the to-be-measured sample. The processing device is configured to perform following processes: collecting the to-be-measured X-ray signal and extracting a plurality of mode signals with different orders; performing a first fitting analysis process on the mode signals whose order is less than a predetermined order, to generate a plurality of initial parameter ranges corresponding to a plurality of structural parameters, respectively; and based on the plurality of initial parameter ranges, performing a second fitting analysis process on the mode signals whose order is greater than or equal to the predetermined order, to generate a plurality of parameter fitting results corresponding to the plurality of structural parameters, respectively.

In order to solve the above technical problems, one of the technical aspects adopted by the present disclosure is to provide an X-ray reflection analysis method utilizing multi-order mode signals, and the X-ray reflection analysis method includes: configuring an X-ray generator to generate a measurement X-ray beam; guiding the measurement X-ray beam to a to-be-measured sample through an X-ray optical component group; receiving, by an X-ray detector, a to-be-measured X-ray signal generated by the measurement X-ray beam irradiating the to-be-measured sample; and configuring a processing device to perform following processes: collecting the to-be-measured X-ray signal and extracting a plurality of mode signals with different orders; performing a first fitting analysis process on the mode signals whose order is less than a predetermined order, to generate a plurality of initial parameter ranges corresponding to a plurality of structural parameters, respectively; and based on the plurality of initial parameter ranges, performing a second fitting analysis process on the mode signals whose order is greater than the predetermined order, to generate a plurality of parameter fitting results corresponding to the plurality of structural parameters, respectively.

Therefore, in the X-ray reflection analysis system and the X-ray reflection analysis method utilizing multi-order mode signals provided by the present disclosure, by capturing sensitive characteristics of higher-order mode signals to fine variations in the three-dimensional structure, required measurement angular range can be significantly reduced. As a result, the measurement time can be greatly shortened, and the throughput of the measurement results can be increased.

In addition, the X-ray reflection analysis system and the X-ray reflection analysis method utilizing multi-order mode signals provided by the present disclosure also employ at least two fitting models, each characterized by fast computation and high accuracy, to significantly reduce the time required for the three-dimensional electromagnetic wave fitting model.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of the X-ray analysis system utilizing multi-order mode signals according to one embodiment of the present disclosure;

FIG. 2 is a cross-sectional schematic diagram of a to-be-measured sample according to one embodiment of the present disclosure;

FIG. 3 is a reflection spectrum diagram of mode signals with different orders obtained under different structural parameters according to one embodiment of the present disclosure;

FIG. 4 is a plot diagram showing variations in reflectance of mode signals with different orders under different structural parameters according to one embodiment of the present disclosure;

FIG. 5 is a flowchart of the X-ray analysis method utilizing multi-order mode signals according to one embodiment of the present disclosure;

FIG. 6 is a detailed flowchart of step S13;

FIG. 7 is a schematic diagram of diffraction patterns produced after an X-ray beam is reflected from the to-be-measured sample according to one embodiment of the present disclosure;

FIG. 8 is a curve diagram of separated mode signals of each order according to one embodiment of the present disclosure;

FIG. 9 is a schematic diagram of fitting using the EMA model according to one embodiment of the present disclosure;

FIG. 10 is a detailed flowchart of step S15;

FIG. 11 is a flowchart of a pre-simulation process according to one embodiment of the present disclosure; and

FIG. 12 is a plot diagram of signal intensities versus linewidths according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

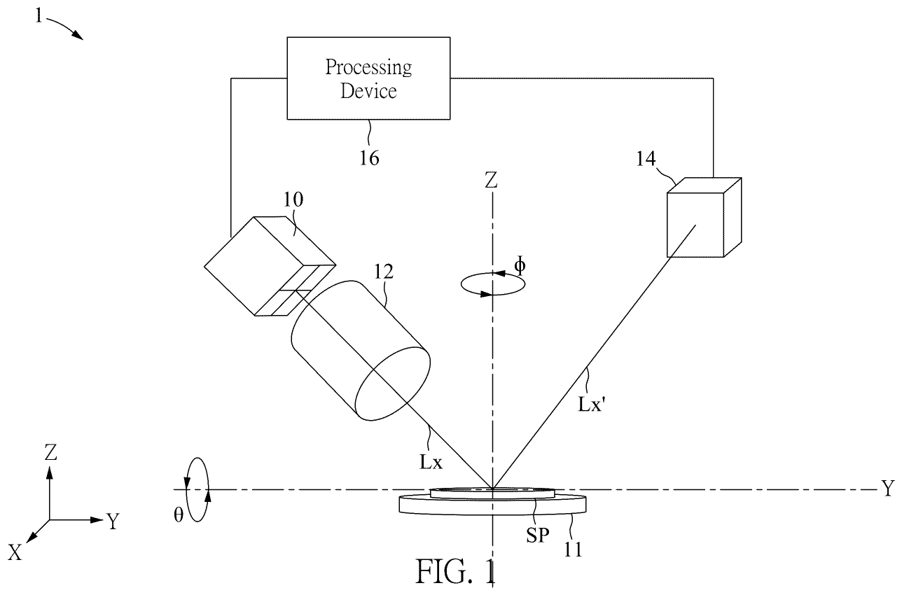

FIG. 1 is a schematic diagram of the X-ray analysis system utilizing multi-order mode signals according to one embodiment of the present disclosure. As shown in FIG. 1, the embodiment of the present disclosure provides an X-ray analysis system 1, which includes an X-ray generator 10, an X-ray optical element group 12, an X-ray detector 14, and a processing device 16. The X-ray generator 10 can include an X-ray tube, which is equipped with an electron beam emitter and a target material. The target material is irradiated by an accelerated electron beam to generate the measurement X-ray beam Lx. Additionally, different target materials, such as copper (Cu), iron (Fe), and molybdenum (Mo), can be selected to generate measurement X-ray beams Lx with different energies or wavelengths (or frequencies).

The X-ray optical element group 12 is used to direct the measurement X-ray beam Lx to a to-be-measured sample SP. The to-be-measured sample SP can, for example, be a gate-all-around and complementary field effect transistor (GAA-FET) structure, or a three-dimensional NAND flash memory with high aspect ratio structures stacked and interconnected in a vertical direction.

The to-be-measured sample SP can be placed on a multi-axis sample stage 11, which, for example, can be a multi-axis movable stage, such as a three-axis tilting platform or a gimbal-type tilting platform, used to support the to-be-measured sample SP. The multi-axis sample stage 11 can be provided with a stage movement mechanism and a stage rotation mechanism. The stage movement mechanism can, for example, include stepping motors corresponding to three axes, used to move the to-be-measured sample SP along one or more of the X, Y, and Z axes. By controlling the stepping motors for each axis, the to-be-measured sample SP can be precisely positioned at different locations. Taking the gimbal-type tilting platform as an example, the stage rotation mechanism can, for example, include a gimbal joint connected to a platform portion, allowing the to-be-measured sample SP to be rotated around one or more of the X, Y, and Z axes. The rotation mechanism of the multi-axis sample stage 11 can include controlling an azimuth angle θ for rotation around the Y-axis and the azimuth angle Φ for rotation around the Z-axis, thus enabling full-angle scanning of the to-be-measured sample SP.

The X-ray optical element group 12 can include one or more X-ray optical elements. For example, the X-ray optical element group 12 can include an X-ray mirror assembly, an X-ray slit, and an X-ray optical collimator sequentially arranged between the X-ray generator 10 and the to-be-measured sample SP. The X-ray mirror assembly can have a multi-layered structure to focus the measurement X-ray beam Lx both horizontally and vertically. The X-ray slit can be used to control the flux of the measurement X-ray beam Lx incident onto the to-be-measured sample SP and a vertical divergence angle of the measurement X-ray beam Lx. The measurement X-ray beam Lx is primarily used in X-ray analytical techniques, and can, for example, be an X-ray beam with a wavelength range greater than 0.1 nm, and can include hard X-rays, soft X-rays, or gamma-ray beams.

When the measurement X-ray beam Lx is irradiated onto the to-be-measured sample SP, depending on the incident angle, various phenomena such as reflection, diffraction, scattering, or penetration will generate a to-be-measured X-ray signal Lx′. By placing the X-ray detector 14 at an appropriate position, it can receive the aforementioned to-be-measured X-ray signal Lx′ generated by reflection, diffraction, scattering, or penetration, and generate corresponding X-ray spectral information. The X-ray detector 14 can be a detector with spatial resolution of one or more dimensions and can receive the to-be-measured X-ray signal Lx′ with energy greater than 1 keV. The X-ray detector 14 can also be, for example, a photosensitive coupling device (CCD) or CMOS image sensor in a two-dimensional array, or a sensor unit (such as a silicon drift detector, SDD) used to capture complete diffraction patterns. In one embodiment of the present disclosure, to obtain the multi-order mode signals, a vertical integration mode can be applied to the two-dimensional sensor array to process the received signals. The corresponding mode signals are extracted at specific angular positions based on the order to be further used for subsequent fitting analysis.

The processing device 16 can be, for example, a computer system including a processor and memory. The processing device 16 can be configured to execute stored instruction sets or codes to control the X-ray generator 10 to generate the measurement X-ray beam Lx, and to perform subsequent analysis on the to-be-measured X-ray signals Lx′ received by the X-ray detector 14.

During the measurement process, the processing device 16 can control the multi-axis sample stage 11 to move and/or rotate, allowing the X-ray detector 14 to receive multiple to-be-measured X-ray signals Lx′ generated at multiple X-ray measurement angles and generate corresponding X-ray spectral information for each of the to-be-measured X-ray signals Lx′.

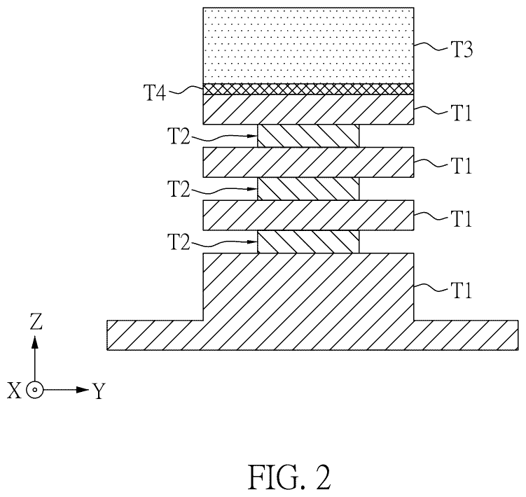

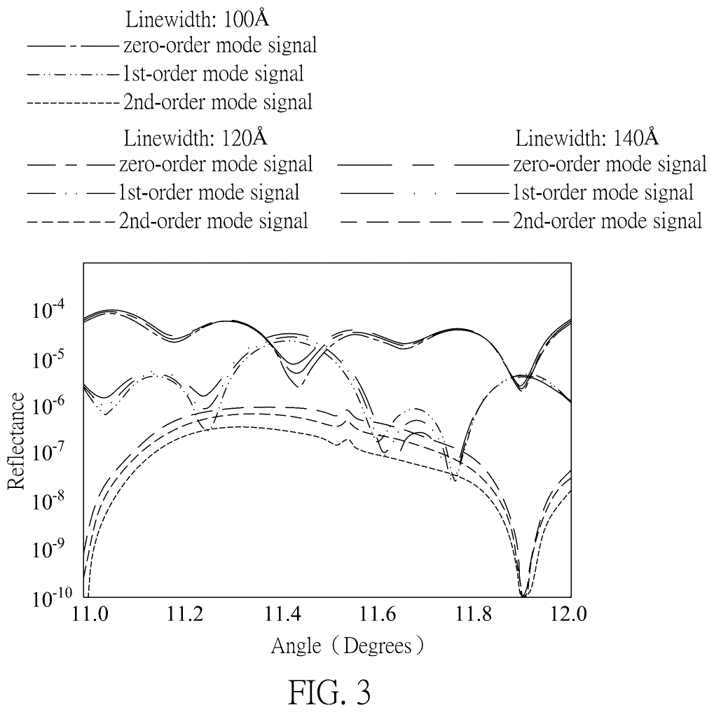

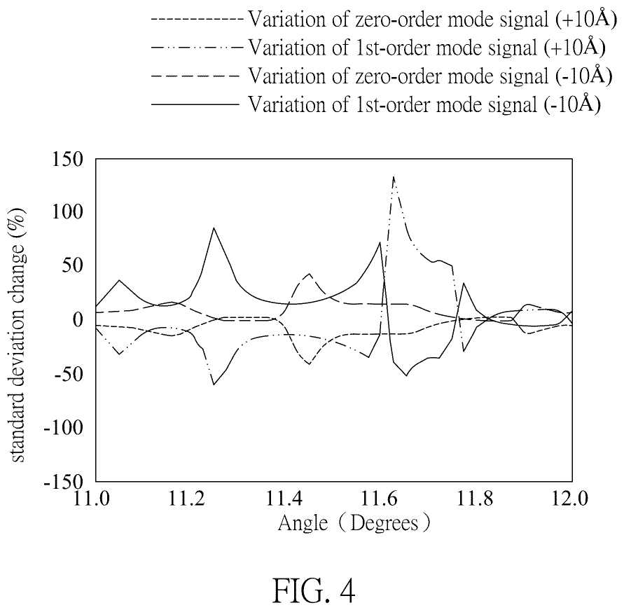

FIG. 2 is a cross-sectional schematic diagram of a to-be-measured sample according to one embodiment of the present disclosure, FIG. 3 is a reflection spectrum diagram of mode signals with different orders obtained under different structural parameters according to one embodiment of the present disclosure, and FIG. 4 is a plot diagram showing variations in reflectance of mode signals with different orders under different structural parameters according to one embodiment of the present disclosure. Referring to FIGS. 2 to 4, the to-be-measured sample SP can have multiple target structures arranged periodically, and the target structure may, for example, be a multilayered component. The target structure has multiple structural parameters, which can include one or more of a thickness, a linewidth, and roughness of each layer.

For example, the to-be-measured sample SP can be configured with multiple periodically arranged GAA-FETs. As shown in FIG. 2, each GAA-FET has multiple stacked layers of silicon-germanium (SiGe) layers T1 and silicon layers T2, with a silicon nitride layer T3 and a silicon dioxide layer T4 sequentially arranged on top. Generally, dimensions of the SiGe layer in X and Y directions are considered critical dimensions (CDs), which are key indicators determining power and performance characteristics of a GAA-FET device.

In this embodiment, lengths of the SiGe layer in the X and Y directions is referred to as the line width. Zero-order mode signals, first-order mode signals, and second-order mode signals obtained at different line widths, such as 110 Å, 120 Å, and 130 Å, are shown in FIG. 3. Signal variations caused by variations in the linewidth are shown in FIG. 4. From FIGS. 3 and 4, it can be seen that within a specific angular range, higher-order mode signals (first-order, second-order mode signals) exhibit more significant reflectivity changes compared to the lower-order mode signal (zero-order mode signals) under the same line width variation. In other words, higher-order mode signals (first-order, second-order mode signals) have higher sensitivity to the linewidth at specific angles. Based on this phenomenon, the higher-order mode signals of different orders measured within a specific angular range can be regarded as important information for fitting analysis, which in turn can be used to determine the CDs (i.e., the structural parameters of the to-be-measured sample SP). It should be noted that, although the zero-order mode signal has lower sensitivity, it still holds reference value when used to roughly estimate ranges of structural parameters.

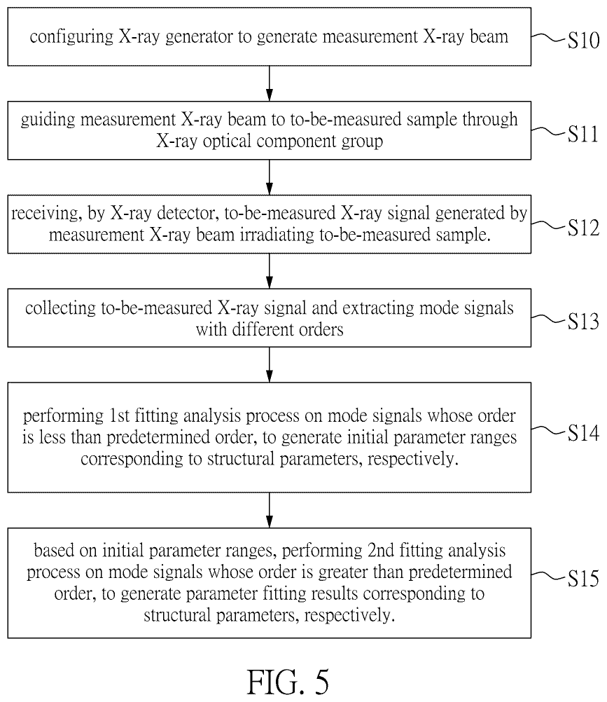

Based on the above analysis, the present disclosure further provides an X-ray reflection analysis method utilizing multi-order mode signals. Reference is made to FIG. 5, which is a flowchart of the X-ray analysis method utilizing multi-order mode signals according to one embodiment of the present disclosure, and the X-ray analysis method at least includes the following steps:
Step S10: configuring an X-ray generator to generate a measurement X-ray beam.
Step S11: guiding the measurement X-ray beam to a to-be-measured sample through an X-ray optical component group.
Step S12: receiving, by an X-ray detector, a to-be-measured X-ray signal generated by the measurement X-ray beam irradiating the to-be-measured sample.

The X-ray reflection analysis method further includes configuring the processing device 16 to perform the following steps:
Step S13: collecting the to-be-measured X-ray signal and extracting a plurality of mode signals with different orders.

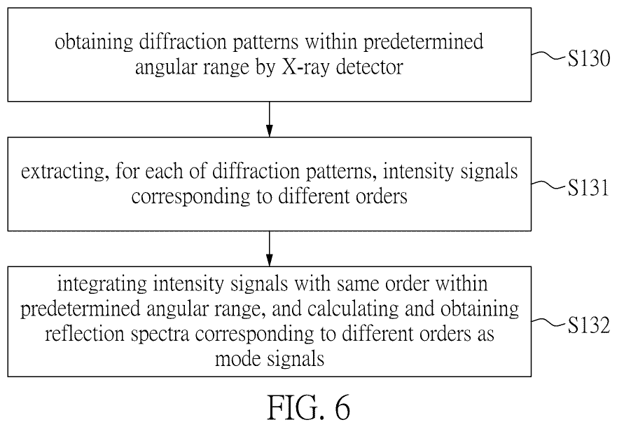

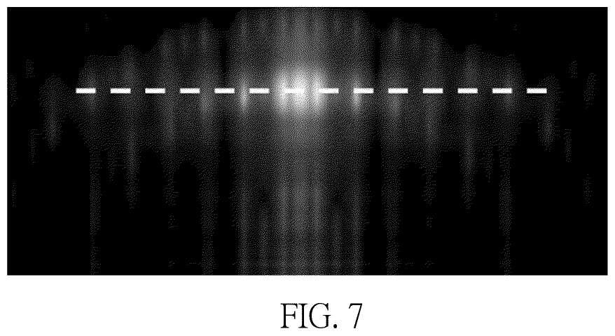

Referring to FIG. 6, FIG. 6 is a detailed flowchart of step S13. As shown in FIG. 6, step S13 includes:
Step S130: obtaining a plurality of diffraction patterns within a predetermined angular range by the X-ray detector.
Step S131: extracting, for each of the plurality of diffraction patterns, a plurality of intensity signals corresponding to the different orders. Referring to FIG. 7, FIG. 7 is a schematic diagram of diffraction patterns produced after an X-ray beam is reflected from the to-be-measured sample according to one embodiment of the present disclosure. For example, the diffraction pattern can first be analyzed to identify an axis region with the highest light intensity (as shown by the dashed line in FIG. 7). This region can be used as a reference to fit the light intensity data using a Lorentzian function, thereby separating the mode signals of each order.
Step S132: integrating the plurality of intensity signals with the same order within the predetermined angular range, and calculating and obtaining a plurality of reflection spectra corresponding to the different orders as the plurality of mode signals.

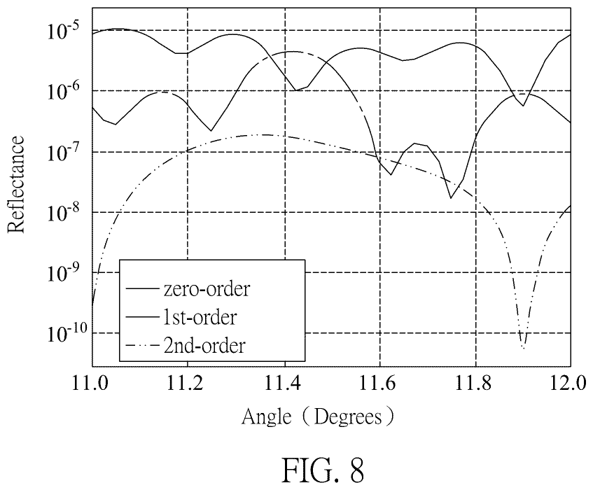

Referring to FIG. 8, FIG. 8 is a curve diagram of separated mode signals of each order according to one embodiment of the present disclosure. In this step, after obtaining the mode signals for each order, the mode signals at different angles can be further integrated to generate data representing variations of reflected light intensity with angle. Then, based on the values of the reflected light intensities, reflectance at different angles can be calculated, as shown in FIG. 8.

Step S14: performing a first fitting analysis process on the mode signals whose order is less than a predetermined order, to generate a plurality of initial parameter ranges corresponding to a plurality of structural parameters, respectively.

In step S14, the first fitting analysis process includes fitting the plurality of mode signals based on a target structure of the to-be-measured sample using an effective medium approximation (EMA) model, so as to generate the plurality of initial parameter ranges corresponding to the structural parameters, respectively. In this embodiment, the predetermined order can be determined based on the mode signals with relatively low sensitivities, such as the zero-order mode signal obtained from the previous analysis. Therefore, the predetermined order is set as the first order, and the mode signals with orders less than the first order can be used in step S14 to quickly estimate parameter ranges of the structural parameters.

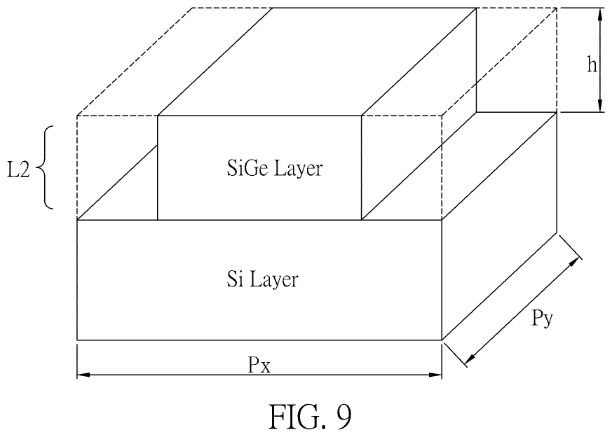

It is worth noting that the EMA model is an analysis or theoretical model used to describe the macroscopic properties of composite materials. This theory derives the properties of a composite material by averaging the properties of each component within the material. Due to the varying and often non-uniform properties of the components that make up the composite material, precise calculations are virtually impossible. As a result, the effective medium approximation theory treats the composite material as a whole, approximating the calculation of parameters and properties of the composite material. FIG. 9 is a schematic diagram of fitting using the EMA model according to one embodiment of the present disclosure. Referring to FIG. 9, during the process of fitting the mode signals based on the target structure, the target structure is equivalent to a layered structure with multiple material layers, with the properties of each layer being described by a volume and a density thereof. For example, when a scale of the silicon-germanium (SiGe) layer is smaller than the underlying silicon (Si) layer, the SiGe layer and the air regions on both sides of the SiGe layer are equivalently treated as a virtual layer L2. The density of this virtual layer L2 is determined using the following equations (1) and (2):

$${ρ}_{eff , L 2} = \frac{{ρ}_{bulk 1 , L 2} * {volumn}_{mater 1 , L 2}}{{volume}_{total , L 2}} + \frac{{ρ}_{bulk 2 , L 2} * {volumn}_{mater 2 , L 2}}{{volume}_{total , L 2}} + … \qquad Equation ( 1 )$$

$${volume}_{t o tal , L 2} = P x * P y * h \qquad Equation ( 2 )$$

Where ρ_{eƒƒ,L2} is the density of the virtual layer L2, ρ_{bulk1,L2} is the density of the SiGe layer, volumn_{mater1,L2} is the volume of SiGe layer, ρ_{bulk2,L2} is the density of air part, volumn_{mater2,L2} is the volume of air part, volume_{total,L2} is the total volume of virtual layer L2, Px, Py, h are the length, width and height of virtual layer L2 respectively.

Therefore, the layered structure with multiple material layers is used as an initial guess model for fitting the zero-order mode signal. The purpose is to take the zero-order mode signal as the fitting target and, through estimating the initial parameter ranges for critical dimensions such as the length and width (i.e., linewidth) of the silicon-germanium (SiGe) layer, achieve a fitting completion condition (e.g., checking for convergence). The initial parameter ranges obtained when the fitting completion condition is met will be taken as fitting results. In addition, structural parameters can also include critical dimensions such as thickness and roughness.

Step S15: based on the plurality of initial parameter ranges, performing a second fitting analysis process on the mode signals whose order is greater than the predetermined order, to generate a plurality of parameter fitting results corresponding to the plurality of structural parameters, respectively.

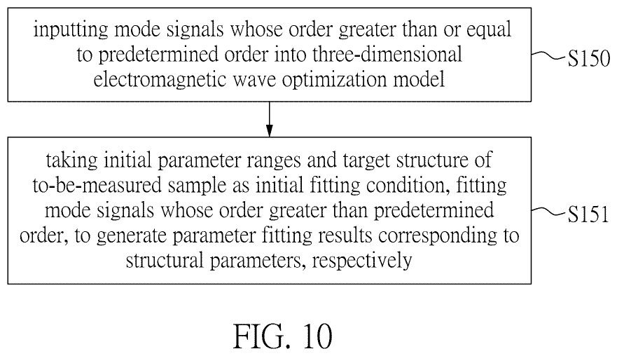

Referring to FIG. 10, FIG. 10 is a detailed flowchart of step S15. In step S15, the second fitting analysis process includes the following steps:
Step S150: inputting the mode signals whose order greater than or equal to the predetermined order into a three-dimensional electromagnetic wave optimization model. In step S150, the predetermined order can, for example, be set to the first order. Therefore, the high-order mode signals, which are more sensitive to linewidth variations, including the first-order mode signals and the second-order mode signals, can be input into the three-dimensional electromagnetic wave optimization model.

In some embodiments, the three-dimensional electromagnetic wave optimization model can, for example, include models established according to one or more of the following algorithms: finite-difference time-domain (FDTD) algorithm, distorted wave born approximation (DWBA) algorithm, rigorous coupled wave analysis (RCWA) algorithm, discrete dipole approximation (DDA) algorithm, and boundary element method (BEM).
Step S151: taking the initial parameter ranges and the target structure of the to-be-measured sample as an initial fitting condition, fitting the mode signals whose order greater than the predetermined order, to generate parameter fitting results corresponding to the structural parameters, respectively.

For example, the initial parameter ranges can be used as the initial fitting condition for the three-dimensional electromagnetic wave optimization model via the transfer matrix method. The first-order mode signals and second-order mode signals can be used as fitting targets for the fitting process. This fitting is performed under the condition that convergence is achieved, generating corresponding parameter fitting results for the structural parameters (such as linewidth, thickness, and/or roughness).

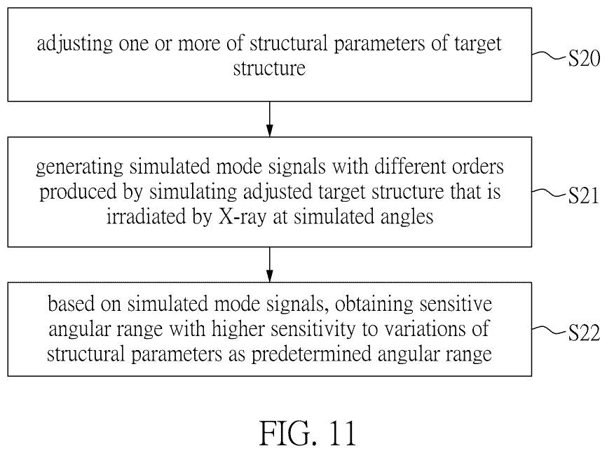

It should also be noted that specific angles at which the mode signals of each order are obtained can be determined. Referring to FIG. 11, FIG. 11 is a flowchart of a pre-simulation process according to one embodiment of the present disclosure. In some embodiments, the predetermined angular range can be obtained through the pre-simulation process, the pre-simulation process includes the following steps:
Step S20: adjusting one or more of the structural parameters of the target structure.

For example, adjustments can be made separately for linewidth, thickness, and roughness, and the angular ranges with higher sensitivity for each order of mode signal can be identified.
Step S21: generating a plurality of simulated mode signals with different orders produced by simulating the adjusted target structure that is irradiated by an X-ray at a plurality of simulated angles.

In this step, based on the adjusted structural parameters, optical simulations can be used to obtain the corresponding simulated mode signals.
Step S22: based on the simulated mode signals, obtaining a sensitive angular range with higher sensitivity to variations of the structural parameters as the predetermined angular range.

Specifically, a reflection spectra graph of different orders of mode signals under various structural parameters, similar to those shown in FIG. 3, can be obtained. The sensitive angular ranges, where the sensitivity of different mode signals is significantly different, can then be identified and used as the predetermined angular range for fitting analysis of specific structural parameters.

Furthermore, for simpler three-dimensional structural size changes, the intensities of multiple orders of mode signals can be compared. Based on the comparison results and corresponding structural changes, the relationship between them can be identified. For example, within the appropriate sensitive angle range, a lookup table can be created that defines a relationship between the relative intensity of each mode signal and the specific linewidth change, and the relationship can be linear or nonlinear. By utilizing this relationship, during measurements within the sensitive angular range, it is only necessary to detect the intensity of each order of mode signal to find the line width variation, thereby significantly reducing the overall measurement time.

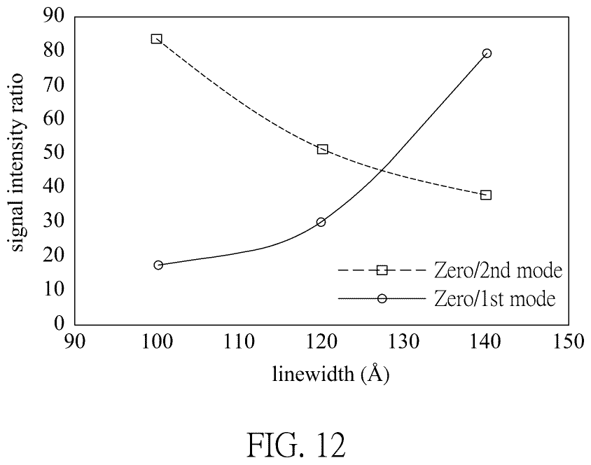

Referring to FIG. 12, FIG. 12 is a plot diagram of signal intensity ratio versus linewidths according to one embodiment of the present disclosure. The relative intensity relationships between the different orders of mode signals can be defined by recording the signal intensity ratios at multiple different linewidths (e.g., zero-order to first-order and zero-order to second-order). Subsequently, a linewidth variation can be directly determined based on the intensities of the separated mode signals, without the need for computational fitting analysis. This further accelerates the overall measurement speed.

### Beneficial Effects of the Embodiments

In conclusion, in the X-ray reflection analysis system and the X-ray reflection analysis method utilizing multi-order mode signals provided by the present disclosure, by capturing sensitive characteristics of higher-order mode signals to fine variations in the three-dimensional structure, required measurement angular range can be significantly reduced. As a result, the measurement time can be greatly shortened, and the throughput of the measurement results can be increased.

In addition, the X-ray reflection analysis system and the X-ray reflection analysis method utilizing multi-order mode signals provided by the present disclosure also employ at least two fitting models, each characterized by fast computation and high accuracy, to significantly reduce the time required for the three-dimensional electromagnetic wave fitting model.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An X-ray reflection analysis system utilizing multi-order mode signals, the X-ray reflection analysis system comprising:
an X-ray generator configured to generate a measurement X-ray beam;
an X-ray optical element group configured to guide the measurement X-ray beam to a to-be-measured sample;
an X-ray detector configured to receive the to-be-measured X-ray signal generated by the measurement X-ray beam irradiating the to-be-measured sample; and
a processing device configured to perform following processes:
collecting the to-be-measured X-ray signal and extracting a plurality of mode signals with different orders;
performing a first fitting analysis process on the mode signals whose order is less than a predetermined order, to generate a plurality of initial parameter ranges corresponding to a plurality of structural parameters, respectively; and
based on the plurality of initial parameter ranges, performing a second fitting analysis process on the mode signals whose order is greater than or equal to the predetermined order, to generate a plurality of parameter fitting results corresponding to the plurality of structural parameters, respectively.

2. The X-ray reflection analysis system according to claim 1, wherein the process of collecting the to-be-measured X-ray signal and extract the plurality of mode signals with the different orders include:
obtaining a plurality of diffraction patterns within a predetermined angular range by the X-ray detector;
extracting, for each of the plurality of diffraction patterns, a plurality of intensity signals corresponding to the different orders; and
integrating the plurality of intensity signals with the same order within the predetermined angular range, and calculating and obtaining a plurality of reflection spectra corresponding to the different orders as the plurality of mode signals.

3. The X-ray reflection analysis system according to claim 2, wherein the first fitting analysis process includes fitting the plurality of mode signals based on a target structure of the to-be-measured sample using an effective medium approximation (EMA) model, so as to generate the plurality of initial parameter ranges corresponding to the structural parameters, respectively.

4. The X-ray reflection analysis system according to claim 3, wherein, during the process of fitting the plurality of mode signals based on the target structure, the target structure is equivalent to a layered structure with a plurality of material layers.

5. The X-ray reflection analysis system according to claim 2, wherein the second fitting analysis process includes inputting the plurality of mode signals whose order is greater than the predetermined order into a three-dimensional electromagnetic wave optimization model, and fitting the plurality of mode signals whose order is greater than the predetermined order by taking the plurality of initial parameter ranges and a target structure of the to-be-measured sample as an initial fitting condition, so as to generate the plurality of parameter fitting results corresponding to the plurality of structure parameters, respectively.

6. The X-ray reflection analysis system according to claim 1, wherein a target structure of the to-be-measured sample is a multi-layer component, and the plurality of structure parameters include one or more of a thickness, a linewidth, and roughness of each layer of the multi-layer component.

7. The X-ray reflection analysis system according to claim 6, wherein the predetermined angular range is obtained through a pre-simulation process, which includes:
adjusting one or more of the plurality of structural parameters of the target structure;
generating a plurality of simulated mode signals with different orders produced by simulating the adjusted target structure that is irradiated by an X-ray at a plurality of simulated angles; and
based on the plurality of simulated mode signals, obtaining a sensitive angular range with higher sensitivity to variations of the plurality of structural parameters as the predetermined angular range.

8. An X-ray reflection analysis method utilizing multi-order mode signals, the X-ray reflection analysis method comprising:
configuring an X-ray generator to generate a measurement X-ray beam;
guiding the measurement X-ray beam to a to-be-measured sample through an X-ray optical component group;
receiving, by an X-ray detector, a to-be-measured X-ray signal generated by the measurement X-ray beam irradiating the to-be-measured sample; and
configuring a processing device to perform following processes:
collecting the to-be-measured X-ray signal and extracting a plurality of mode signals with different orders;
performing a first fitting analysis process on the mode signals whose order is less than a predetermined order, to generate a plurality of initial parameter ranges corresponding to a plurality of structural parameters, respectively; and
based on the plurality of initial parameter ranges, performing a second fitting analysis process on the mode signals whose order is greater than the predetermined order, to generate a plurality of parameter fitting results corresponding to the plurality of structural parameters, respectively.

9. The X-ray reflection analysis method according to claim 8, wherein the process of collecting the to-be-measured X-ray signal and extracting the plurality of mode signals with the different orders include:
obtaining a plurality of diffraction patterns within a predetermined angular range by the X-ray detector;
extracting, for each of the plurality of diffraction patterns, a plurality of intensity signals corresponding to the different orders; and
integrating the plurality of intensity signals with the same order within the predetermined angular range, and calculating and obtaining a plurality of reflection spectra corresponding to the different orders as the plurality of mode signals.

10. The X-ray reflection analysis method according to claim 9, wherein the first fitting analysis process includes fitting the plurality of mode signals based on a target structure of the to-be-measured sample using an effective medium approximation (EMA) model, so as to generate the plurality of initial parameter ranges corresponding to the structural parameters, respectively.

11. The X-ray reflection analysis system according to claim 10, wherein, during the process of fitting the plurality of mode signals based on the target structure, the target structure is equivalent to a layered structure with a plurality of material layers.

12. The X-ray reflection analysis method according to claim 9, wherein the second fitting analysis process includes inputting the plurality of mode signals whose order is greater than the predetermined order into a three-dimensional electromagnetic wave optimization model, and fitting the plurality of mode signals whose order is greater than the predetermined order by taking the plurality of initial parameter ranges and a target structure of the to-be-measured sample as an initial fitting condition, so as to generate the plurality of parameter fitting results corresponding to the plurality of structure parameters, respectively.

13. The X-ray reflection analysis method according to claim 8, wherein a target structure of the to-be-measured sample is a multi-layer component, and the plurality of structure parameters include one or more of a thickness, a linewidth, and roughness of each layer of the multi-layer component.

14. The X-ray reflection analysis method according to claim 13, wherein the predetermined angular range is obtained through a pre-simulation process, which includes:
adjusting one or more of the plurality of structural parameters of the target structure;
generating a plurality of simulated mode signals with different orders produced by simulating the adjusted target structure that is irradiated by an X-ray at a plurality of simulated angles; and
based on the plurality of simulated mode signals, obtaining a sensitive angular range with higher sensitivity to variations of the plurality of structural parameters as the predetermined angular range.
